(19) United States
(12) Patent Application Publication
(10) Pub. No.: US 2017/0109849 A1
(43) Pub. Date: Apr. 20, 2017

(54) Systems And Methods For Generating Personalized Modifiable Pathways And Services

(71) Applicants: Adeboyejo Adetokunbo Oni, Bethesda, MD (US); Olumuyiwa Adetokunbo Oni, Bethesda, MD (US)

(72) Inventors: Adeboyejo Adetokunbo Oni, Bethesda, MD (US); Olumuyiwa Adetokunbo Oni, Bethesda, MD (US)

(21) Appl. No.: 14/883,424

(22) Filed: Oct. 14, 2015

(51) Int. Cl. G06Q 50/20

(52) U.S. Cl. CPC G06Q 50/2053

(57) ABSTRACT

Systems and related methods for generating personalized, modifiable pathway options and services are disclosed. Services, such as an assessment or advisor service, may be provided in combination with the pathway options. Gaps in the completion of a particular pathway can be analyzed and corrected.

### RELATED APPLICATION

This application is related to U.S. patent application Ser. No. 10/657,562 (the “'562 application”) now U.S. Pat. No. 7,299,217 and incorporates by reference herein in its entirety the disclosure of the '562 application as if set forth in full herein.

### INTRODUCTION

In order to be successful in accomplishing life's goals, it is often important for a person to establish, and follow through with, a well-conceived plan or more precisely an executable pathway towards a goal, be it a life-style, health-related, career, education or other type of goal.

With respect to educational goals, an individual may potentially choose from a large number of institutions, majors, programs, curricula, courses and funding sources in order to successfully pursue his or her education goals. Given such a large number of choices, the task of developing an executable pathway towards a goal can be difficult and overwhelming. Furthermore, education and training prerequisites and requirements for a given educational program, institution or degree can be very subjective, varying from one institution to another. As a result, an individual who is attempting to understand such prerequisites and requirements typically realizes that such an understanding is fraught with the unexpected, namely, prerequisites and requirements that are difficult to ascertain in advance.

Many times the development of an executable education pathway is closely related to the development of an executable career pathway due to the fact that the goal of many education pathways is to obtain an education which qualifies the individual for a specific, potentially rewarding career in a given field, while the individual continues to pursue other life endeavors.

While there exist systems that provide educational and career plans, such plans are fairly general, and lack the capability of being updated in a timely fashion. Thus, such plans become quickly outdated as time passes.

Accordingly, it is desirable to provide improved systems and methods for generating personalized pathways related to education, health, careers and other life endeavors that allows for the use of a large amount of information and variables that are personal to a given user. Further, it is desirable to provide improved systems and methods for generating personalized pathways where the pathways may be modified over time to reflect changes to user's achievements, preferences and goals, for example.

Still further, it is desirable to provide services to users related to education, health, careers and other life endeavors.

### SUMMARY

In accordance with the present invention, embodiments are provided that generate personalized, modifiable pathways towards a goal.

In one embodiment, a system for providing a pathway towards a goal may comprise a hardware platform configured as a service oriented architecture (“SOA”). The platform may operable to generate one or more personalized, modifiable and executable pathway options towards a defined goal based on personalized information, and output the personalized, modifiable and executable pathway options.

In more detail the platform may be operable to output personalized, modifiable and executable pathway options in combination with: (i) a student-related service, (ii) a college application-related service, (iii) an advisor-related service, (iv) an employer-related service; (v) one or more assessment related services; (vi) an investigative service; or (vii) a work opportunity service, to name just a few of the types of services.

In addition to the platform, a system may also comprise one or more user devices, each device being operable to receive personalized, modifiable and executable pathway options that have been output from the platform. Such user devices may send personalized information to the platform. The user devices may be wired or wireless, and may be part of the same or different networks. The user device may comprise a user interface for communicating with the platform.

In additional embodiments the platform may further comprise a dynamic rules section (or “engine” for short) that is operable to detect a modification in the personalized information or an element or component of a personalized, modifiable and executable pathway option, and insure that all constraints are met so that the modification does not violate one or more rules. Alternatively, the engine may be a standalone system that is operable to exchange communications with the platform in order to work in conjunction with the platform.

One example of an element is an academic course of instruction, while one example of a component is an academic course listing and associated requirements of an academic semester or quarter.

Constraints may comprise both user constraints and organic rules and organic constraints, where the organic constraints include those constraints that are applicable to a selected academic school or institution (e.g., academic course and curricula rules and constraints).

In embodiments of the invention the services provided by the platform may comprise a free service, or freemium service or subscription service.

Still further, an exemplary system may further include: (a) a user assessment section that is operable to apply results of an assessment to potentially viable pathway elements and components to modify and reduce a number of potentially viable pathway elements and components and output modified, personalized executable pathway options associated with an assessment service; and (b) a gap analysis section that is operable to receive one or more personalized executable pathway options, identify a component or element that is not being executed correctly, identify one or more follow-on, next components or elements that will be ineligible to be executed, based on the identified, incorrectly executed components or elements for the user, and output alternative element equivalents to the dynamic rules section to regenerate personalized executable pathway options as replacement for the component or elements that are not being executed correctly.

An alternative system provided by the present invention may comprise (1) a hardware platform configured as a service oriented architecture operable to generate one or more personalized, modifiable and executable pathway options towards a defined goal based on personalized information, and output the personalized, modifiable and executable pathway options; and (2) a dynamic rules section operable to detect a modification in the personalized information or with an element or component of a personalized, modifiable executable pathway option, and insure that all constraints are met so that the modification does not violate one or more rules.

In addition to the systems just described, the present inventors provide for one or more authenticated user devices, each device operable to receive personalized, modifiable and executable pathway options based on personalized information from a hardware platform in combination with an associated service. Each device may be further operable to send the personalized information to the platform.

In accordance with embodiments of the invention, each device may comprise a user interface for communicating with the platform.

### BRIEF DESCRIPTION OF THE DRAWINGS

FIG. 1 depicts a block diagram of an exemplary system according to one embodiment of the invention.

FIG. 2 depicts another block diagram of an exemplary system that shows an expanded view of an exemplary integrator section according to an embodiment of the invention.

FIG. 3 depicts a block diagram of an exemplary pathway organizing platform according to one or more embodiments of the present invention.

FIG. 4 depicts an exemplary “dashboard” that may be displayed as a part of one or embodiments of the present invention.

### DETAILED DESCRIPTION, WITH EXAMPLES

Exemplary embodiments of systems and methods for generating personalized, modifiable pathways towards a goal are described as well as associated services. It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

For example, though the systems and methods described herein focus on the generation of executable, personalized, modifiable pathways to reach educational goals and associated services, it should be understood that this is for illustrative purposes only, it being further understood that the systems and methods may be applied to other types of executable pathways to reach other types of goals, such as career, health, or life-style goals to name just a few of the many different types of goals.

As used herein the phrase “modifiable” includes, but is not limited to, information that may continuously change over time, or information that is temporally adaptive (i.e., evolves in parallel with a user's changing desires, preferences, achievements, etc).

It should be understood that when the description herein describes the use of an “platform”, “tool”, “engine” or “integrator” that such a platform, tool, engine, or integrator may include one or more devices. For example, the devices may include one or more hardware servers, as well as one or more processors, memories, caches and databases. The servers and processors may be operable to execute stored, specialized instructions for completing associated, described features and functions. Such instructions may be stored in an onboard memory, in separate memory, or specialized database for example. Such instructions represent functions and features that have been integrated into memory.

It should also be understood that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method.

Another phrase (or phrases) is “organic rules” and “organic constraints”. Exemplary examples of such rules and constraints are academic, course and curricula rules and constraints.

Yet another phrase is “user”. As used herein a user is an individual that exchanges information with systems, devices and platforms provided by the present invention. Exemplary non-limiting examples of a user are a student of an academic institution, an administrator of an academic institution, an individual interested in a trade or vocation, and an individual involved in the process of employing other individuals.

Throughout the description herein the phrases “plan”, “plan outcome”, “goal”, “path outcome”, “path component”, “path element” and “pathway” may be used. When so used these phrases mean at least the following, unless the context dictates otherwise:

pathway: an organized, executable and unique matching collection of sequential and concurrent path components that, taken together, constitute a plan;

element: the smallest, self-contained executable element of a path component associated with a coherent cost and duration;

component: a self-contained, executable set of path elements that are chronologically sequential or simultaneous;

pathway options: formatted or unformatted data, and instructions that may be sent to, or exchanged with, a user device that allows the device to display or otherwise present information, such as information related to a service or information related to an element, component, pathway, plan, goal, queries, surveys, assessments, milestones or some combination of the above, for example, to a user in order to allow the user to use a service and/or accept, reject or modify plans and pathways or modify personalized information;

personalized information: information related to a user, such as a user's desires, achievements, likes/dislikes, and interests, for example, related to academics (high school college, graduate school), a profession, apprenticeship, vocation, life-style, or health for example;

plan: an executable pathway; an organized and matching collection of path outcomes; and

goal: a targeted path outcome or pathway milestone.

In an embodiment of the invention, some non-limiting examples of the phrases set forth above are as follows: plan—a collection of path components for an individual leading to a Master of Science (M.S.) degree in Biology; element—curriculum rules, academic course and curriculum tasks, (e.g., a given course, such as an engineering course typically called “Mechanics I” that is required during the second semester of the first or freshmen year in a BS program); and component—an academic course listing and associated requirements of an academic semester or quarter. (e.g., the first semester of a specific year, such as the second or sophomore year, of a BS degree program).

Exemplary examples of a “milestone” are a high school diploma or equivalent, or a vocational, associate's, bachelor's, master's, doctoral or professional certification degree in an academic disciplinary.

In embodiments of the invention an example of a “personalized, modifiable and executable pathway option” is information received by a user from a platform in response to the user's input of her/his desires, achievements, likes/dislikes, and interests, for example, related to academics, a profession, apprenticeship, vocation, life-style, or health that allows the user to use a service and/or accept, reject or modify plans and pathways sent to the user (it being understood that the plans and pathways may be options themselves), where the options continuously change over time, or evolve in parallel with the user's input or input from another source that is associated with the user.

As noted above, and reiterated here, the exemplary examples and embodiments presented herein are only some of the many that fall within the scope of the present invention, it being practically impossible for the inventors to list all of the many possible exemplary examples and embodiments that fall within the scope of the present invention.

As used herein, the term “and/or” includes any and all combinations of one or more of the associated listed items. As used herein, the singular forms “a,” “an” and “the” are intended to include the plural form, unless the context and/or common sense indicates otherwise. It should be further understood that the terms “comprises”, “comprising,”, “includes” and/or “including”, when used herein, specify the presence of stated features, systems, subsystems, steps, operations, elements, and/or components, but do not preclude the presence or addition of one or more other features, systems, subsystems, steps, operations, elements, components, and/or combinations thereof.

As used herein the phrases “connection”, “connected to”, “associated with”, or similar phrases means an indirect or direct physical connection between at least two different parts of a platform, device or system, or means one part of a platform, device or system is subsumed within (and thereby connected to) at least one other part of a platform, device or system. It should be understood that when one part of a platform, device or system is described or depicted as being connected to another part, other well known components used to facilitate such a connection may not be described or depicted because such components are well known to those skilled in the art.

Yet further, when one part of a platform, device or system is described or depicted as being connected to another part using “a connection” (or single line in a figure) it should be understood that practically speaking such a connection (line) may comprise (and many times will comprise) more than one physical connection or channel, may be omni-directional or bi-directional, and may or may not include separate data, formatting and signaling.

Still further, it should be understood that a user device that completes features and functions of embodiments of the invention may include a web browser that is a part of a user interface or one or more applications (often referred to herein as an “app” or “apps”) that have been installed into, or downloaded onto, a user device or client-side device. An “app” may include “content” (e.g., text, audio and video files), signaling and configuration files. For the sake of convenience and not limitation, the terms “app” or “application” are used herein to refer to any application, but use of such a term also includes a reference to any file or data.

In one embodiment, an app to be downloaded onto a user or client-side device may also reside or be stored on one or more hardware devices, such as a server in whole and/or in part, the later indicating that the app may be distributed among, and by, a number of devices (servers). An app may be downloaded to a user device from an app server (or servers as the case may be) or have been otherwise provided and installed on such a server. A given user or client-side device may have a need for one or more of the apps installed on a server. Accordingly, it should be understood that each of the embodiments described herein includes protocols, necessary hardware, software and firmware resident on a user/client-side device for transmitting and receiving (i.e., “transceiving”) an app, content and/or content identification information relating to the app from/to a server and vice-versa. It should be understood that depending on the content to be transmitted, an app may be installed directly on a user device or client-side device or may be downloaded from a server by initiating a request to a server to receive a local copy of the app.

It should be noted that the platforms, systems and devices, as well as any subsystems, etc., thereof, illustrated in the figures are not drawn to scale, are not representative of an actual shape or size and are not representative of any actual system or device layout, or manufacture's drawing. Rather, the platforms, systems and devices are drawn so as to help explain the features, functions and processes of exemplary embodiments of the present invention described herein and covered by the claims set forth at the end of this description.

As used herein, the term “embodiment” refers to one example of the present invention.

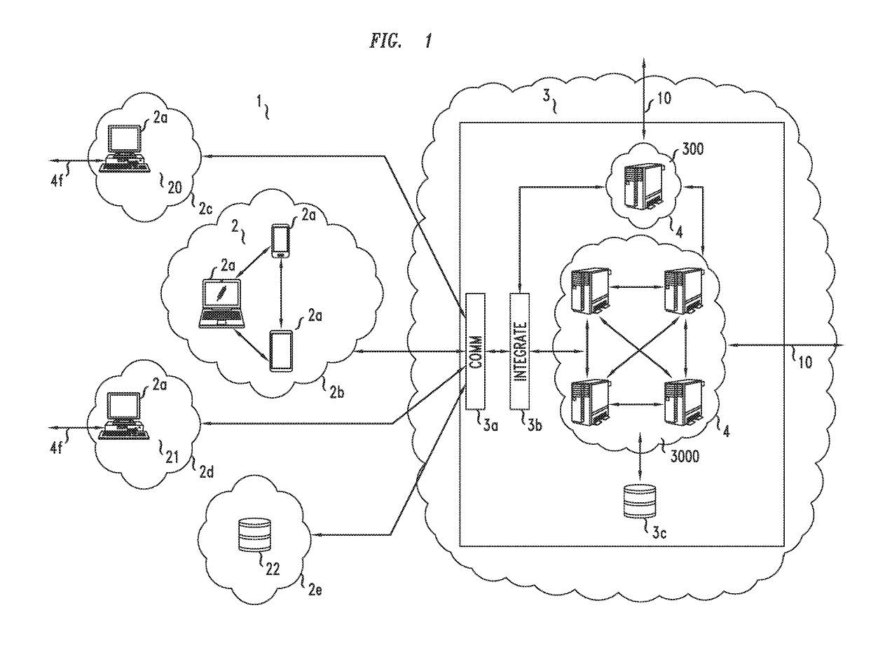

Turning now to FIG. 1, there is depicted a block diagram of an overall system 1 for generating personalized, modifiable pathways towards a goal and for providing associated services according to one or more embodiments of the present invention.

In one embodiment the system 1 may comprise a device 2 and an overall platform 3. The device 2 may be part of a network 2b and may comprise a user or client-side device (hereafter “user device”). The device 2 may comprise a wired or wireless device, a desktop computer, a laptop computer, tablet, phablet, hand-held device, terminal, a virtual machine, or server to name just a few examples. Such devices may be located locally or remotely from the overall platform 3. Therefore, such devices may include hardware for connecting the device 2 and user interface 2a to the network 100 and platform 3 via wired or wireless means known to those skilled in the art.

The device 2 may include a user interface 2a. Some non-limiting examples of a user interface 2a are a graphical user interface (GUI), web browser, keyboard, touch screen, visual display, voice recognition system or some combination of such devices, to name but a few of the many examples of a user interface. The user interface 2a may be used to access, and to exchange communications with, the overall platform 3 via a web browser or an app, for example. The user interface 2a may comprise the necessary electronics (such as one or more processors) specially designed and programmed to complete the features and functions described herein by, for example, accessing integrated instructions stored in memory and/or data stored in memory.

In one embodiment the overall platform 3 may be part of a network 100. The network may be a wired or wireless network, such as the Internet, a Intranet, secure network, 3G, 4G, 5G or more advanced network, local area network (LAN), or wide area network (WAN) to name just a few of the many types of networks 100. As indicated above, in some embodiments device 2 may communicate with platform 3 via one or more apps.

As shown in FIG. 1 the overall platform 3 may comprise a communications and administrative section 3a, an integrator section 3b, partial features platform 300 and full-featured platform 3000. Together, platforms 300,3000 may be referred to collectively as a “pathway and service platform” 4. One example of platform 4 is a SOA. That is to say, one or more primary, functional parts of platform 4 may be configured to selectively communicate with specialized, functionally supportive parts of platform 4 that are operable to provide specific functions, such as “utility” functions (e.g., binder and notification functions). In accordance with embodiments of the invention, primary parts of platform 4 (e.g., sections 3a, 3b, 300, 3000) that are operable to provide an associated service may only select certain utilities rarely, if at all, and, conversely may select other utilities quite often. In accordance with a SOA embodiment of the present invention, those parts of platform 4 that are responsible for providing such utilities need not reserve resources (e.g., processing, memory) in order to constantly support each and every primary part of platform 4. Instead, in accordance with embodiments of the invention each primary part of platform 4 may request assistance from a supportive part on an “as needed” basis (e.g., only when a primary part requires a notification to be generated and sent). Accordingly, the platform 4 makes more efficient usage of its resources.

Yet another example of platform 4 is a plurality of servers that are part of a cloud-based data center or data centers. Of course the servers may be configured using a SOA as well.

It should be understood that while the overall platform 3 is shown as including four separate sections this is merely exemplary. Alternatively, the sections 3a, 3b, 300 and 3000 may be combined into fewer sections or further separated into additional sections. One or more of sections 3a, 3b, 300 and 3000 may be co-located at, or near, the same location or located at different locations. Further, the one or more sections making up overall platform 3 may take the form of one or more computing devices (e.g., one or more hardware servers) that are specially programmed to execute instructions stored in memory and to access data stored in specialized memories (databases 3c) to provide the services selected by a user. Yet further, the functions completed by each section 3a, 3b, 300 and 3000 may be distributed, that is, the functions may be separated into individual or grouped functions that are completed by separate devices. Similar to pathway and service platform 4, one example of overall platform 3 are servers that are part of a cloud-based data center or data centers. Yet another is a plurality of virtual machines stored on a server or computer, for example.

Regarding databases 3c, these databases may be operable to store information in the form of text, audio, video, image or some combination of such information in a plurality of desired formats for ease of storage, retrieval and eventual usage by platforms and user devices described herein. Further, in an embodiment of the invention, one or more of the platforms described herein may be operable to provide content within databases 3c to a user (user device) as part of a content-as-a-service. Such a service may be provided to the user as a standalone service or may be combined with other information, such as personalized, modifiable pathway options, and information from another service, and provided to a user. The content may be sent to a user device and then displayed to a user via a user interface.

In one embodiment of the invention, platforms described herein may be operable to select certain content from databases 3c that a platform has determined best match input provided by a user (e.g., a user's desires, preferences). By way of non-limiting examples, the content may be a video, image (e.g., picture) or an audio-video presentation of an individual engaged in a certain occupation, or an individual describing the typical duties of a particular occupation, for example, where the occupation was one that a user indicated to the platform (i.e., communicated to the platform) she had interest in. Alternatively, platforms described herein may be operable to provide a user with information that allows a user interface to display a “search” form or dashboard. Such a search form would allow a user to input certain key words or select other types of filters in order to select the type of content he or she desires to review. In embodiments of the invention, the user's input and selections are communicated to the platforms described herein. Upon receiving this input the platforms described herein may be operable to determine which content stored in databases 3c best match the key words or filters input by the user, and then send the determined content to the user's device to be displayed by a user interface.

As mentioned above the content-as-a-service may be combined with one or more other services described herein. For example, an Assessment Service. In one embodiment, platforms provided by the present invention may be operable to relate the results of a particular assessment to content within databases 3c and then provide this content to the user's device. For example, if the result of one assessment indicates a user may have a proficiency in math, then a platform described herein may select and send content related to scientific courses of study, occupations and jobs to a user.

Continuing with a discussion of system 1, in one embodiment a user of device 2 may access either the partial feature platform 300 or full featured platform 3000 or both platforms 300, 3000 depending on whether the user has been granted access to free or “freemium” features and functions (and corresponding services) by section 3a, for example, or has been granted access to subscription-based features and functions (and corresponding services) after providing a payment using an app, for example. Section 3a may comprise a communications hub operable to provide web-based services, a hardware server (or servers), or virtual machines stored on a server or computer, for example. Section 3a may be operable to exchange communications with a user of device 2 (or 20, 21) in order to grant, or deny, the user access to a part of platform 3 using one or more authentication and registration processes known in the art.

In one embodiment, one app (“first app”) or browser-based communication may provide a user of device 2 with free features and functions by allowing the device 2 to access partial feature platform 300 while another app (“second app”), or another version of the first app or browser-based communication may provide a user with subscription or paid features and functions by allowing the device 2 to access full featured platform 3000, in addition to, or separate from platform 300. It should be understood that while the pathway and service platform 4 is shown as two separate platforms this is merely exemplary. Alternatively, the platforms 300, 3000 may be combined into a single platform or further separated into additional platforms.

In embodiments of the invention, similar to platform 4, some or all of platform 3 may be configured as a SOA. When so configured, platform 3 certain capabilities of such a platform may be activated on an “as needed” basis instead of as on an “always on” basis. Accordingly, when platform 3 (and/or 4) is configured as a SOA the platform is, generally speaking, operable to function in a more efficient, higher performance manner.

As explained further below, the overall platform 3 may comprise a number of systems and subsystems. In embodiments of the invention, rather than be “always on” each of these systems and subsystems may be configured themselves, and in relation to one another, so that each is activated (i.e., “turned on”) only as needed to provide the functionality required to provide a particular capability (e.g., utility) or service. Examples of such utilities include, but are not limited to “notification” and “binder” utilities. In one embodiment, a notification utility generates notifications or messages that may be sent to, or form, a user. Such notifications may be related to the generation of a pathway towards a goal or may be used as part of an associated service, for example.

In one embodiment a binder utility may be operable to store information related to a user, 2 or information that is of interest to such a user, in a storage repository (e.g., memory, cache, database). Such information may comprise information used to formulate a pathway towards a goal, to name just one of the many different types of information that may be stored by a memory or database that is a part of platform 3, for example.

Exemplary notification and binder utilities may also be a part of one or more exemplary services, such as an Advisor service, Assessment service, Investigative service, College Application service, or an Administrative service, to name just a few of the types of services that may include a notification or binder utility.

A user may gain access to the features provided by platforms 3 and/or 4 (and/or directly sections 300, 3000) using one or more apps, or one or more versions of the same app, or through a web based browser, for example. In more detail, a user may be operable to exchange communications with pathway organizing platform 4 directly or via overall platform 3 (e.g., section 3a) in order to grant, or deny, the user access to a part of platform 4 using one or more authentication and registration processes known in the art.

In another embodiment one or more of the functions completed by sections 3a, 3b, 300 and 3000 may be configured as a virtual machine stored on a hardware device, such as a server or a hard drive of a computer.

In an exemplary embodiment the devices 2, 20 and 21 and sections 3a, 3b, 300 and 3000 may comprise the necessary hardware and software for completing all of the functions described herein, and in addition, at least the following functions: communications via a wired or wireless communications link, tracking a user's status as a paid subscriber or freemium user, tracking the features and services that have been selected by a user as a freemium or paid subscriber, completing e-commerce transactions (e.g., payment for subscription services), providing customer support features (e.g., help desk, technical support, billing inquiries, etc.), social networking linkage (e.g., to Face book, Twitter, other accounts), and those functions required to support communications (e.g., notifications) via one or more apps. Similarly, sections 3a, 3b, 300 and 3000 may comprise necessary electronics (such as one or more processors) specially designed and programmed to complete the features and functions described herein by, for example, accessing integrated instructions stored in memory and/or data stored in memory or a database.

In one embodiment, an integrator section 3b may be operable to communicate with the platform 4 and communications and administrative section 3a in order to provide pathway options and integrated and easy-to-use services to the user of device 2. It should be understood that the user of device 2 may also use many other, different devices to communicate with platform 3 in order to, for example, to generate pathways and pathway options, access a service provided by platform 3, access data stored within platform 3, or access external content via connections or channels 10. Rather than repeat the description that follows for every conceivable type of device 2 the user may choose to use, for present purposes, in order to simplify the description herein the systems and methods provided by embodiments of the present invention apply regardless of the type of device 2 in use by the user.

In addition to communicating with platform 4 and receiving information in the form of data or signals from external (e.g., third party sources), integrator section 3b may be operable to communicate with an advisor device 20 within network 2c, and/or an employer device 21 within network 2d. The communications between the integrator section 3b and the devices 2, 20, 21 may include one or more services as described elsewhere herein.

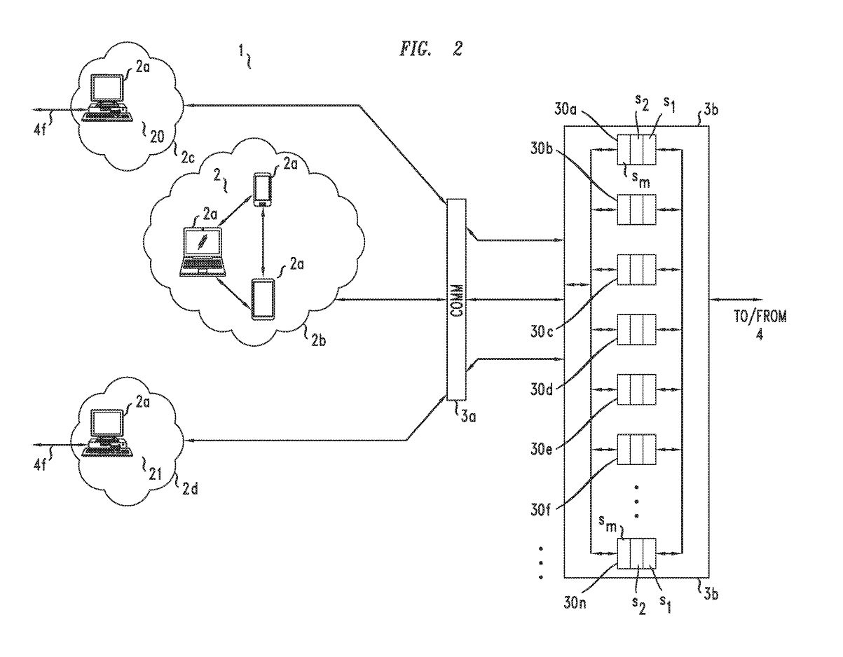

Referring now to FIG. 2 there is depicted another block diagram of the system 1 that shows an expanded view of an exemplary integrator section 3b according to an embodiment of the invention. As shown section 3b may include a plurality of pathway segments 30a, 30b, . . . 30n where “n” indicates the last segment. In turn each of the segments 30a, 30b, . . . 30n may include a plurality of sub-segments denoted s₁, s₂, . . . sₘ where “m” indicates a last sub-segment within a segment. It should be noted that though section 3b is depicted as including a plurality of segments 30a, 30b, . . . 30n one or more (e.g., all, fewer than all) of these segments may be combined. Yet further, a particular sub-segment that is part of one segment may also be part of one or more other segments.

The features and functions described above and herein may form a service or services that may be provided by the one or more segments 30a, 30b, . . . 30n and sub-segments s₁, s₂, . . . sₘ to a user. In one embodiment each of the sub-segments s₁, s₂, . . . sₘ may be operable to provide a subset of the features and functions provided by the platform 4 as one or more services, for example, to the user of device 2, 20, 21. In embodiments of the invention, services provided by a segment (or sub-segment) may be associated with one or more apps. That is, one app may provide a first service associated with one or more segments (or sub-segments) while a second app may provide a second service that is distinct from, or overlaps with the first service (and, therefore, may be provided by the same, different or overlapping segments or sub-segments) used to provide the first service.

It should be understood that each segment 30a, 30b, . . . 30n may be operable to further include information about a given user or users. Such information may consist of a user profile that may be stored in a memory section within each segment 30a, 30b, . . . 30n or in an external database 22 in network 2e. The profiles may be accessed by each segment 30a, 30b, . . . 30n as part of a process to provide a service to a user. The profiles may be updated through communications exchanged by a given user and a given section 30a, 30b, . . . 30n or through communications received from other parts of the system 1, or from external sources (third party).

As mentioned previously, the integrator section 3b may be operable to communicate with the platform 4 in order to integrate the features and functions selected by a user in order to provide pathway options or integrated and easy-to-use services to a user. It should be noted that while section 3b and its segments and sub-segments are depicted as being separate from platform 4 this is merely exemplary. In alternative embodiments one or more of the segments 30a, 30b, . . . 30n or sub-segments s₁, s₂, . . . sₘ may be combined within platform 4 or vice-versa.

In more detail, integrator section 3b (or “integrator” for short) may be operable to receive input (i.e., information, requests) from the device 2, 20, 21 that identifies at least one service a user of device 2,20,21 is interested in receiving. Upon receiving this input, integrator 3b may be operable to integrate or otherwise combine one or more segmented services from one or more of the segments 30a, 30b, . . . 30n and sub-segments s₁, s₂, . . . sₘ to form at least one identified, integrated service that corresponds to the service the user is interested in receiving. Thereafter, the integrator may be operable to provide the integrated service to the user.

It should be understood that the service or services provided to a user of device 2, 20, 21 may be provided without using integrator 3b as well. In either case, the services, including but not limited to, providing a user personalized, modifiable executable pathway options, are generated in conjunction with, or by, platforms 3,4.

Further, it should be understood that the service or services provided to the user may be an “on demand”, real-time service, or, alternatively may comprise a free service, or (“freemium” service), or still further, may comprise a subscription service. Each of the devices 2, 20, 21 may comprise their own user interface for communicating with, and viewing information sent to, or received from, the platform 3. Each of the devices 2, 20, 21 may be in the same or different network 2b, 2c, 2d.

In embodiments of the invention, the platform 3 may provide signals, instructions or data to user devices in order to configure such user devices with interactive and intuitive interfaces (e.g., displays that use multi-media content, formatting). One or more exemplary services provided by the present invention may be “bundled” and provided to a user device together, or provided separately.

Prior to accessing a service provided by the platform 3, a user (i.e., user device) may be required to exchange communications with platform 3 (e.g., section 3a) or another third party registrar to complete an authentication and registration process in order to gain access to one or more of the services provided by platform 3.

In more detail, each of these services may involve an exchange of communications (e.g., a set or series of questions and answers) of personalized information between platform 3 and a user of device 2, 20, 21. It should be understood that personalized information of a user may, and many times does, take the form of electronic signals, such as formatted or unformatted data, and instructions that may be sent to, or exchanged with, the device 2, 20, 21 and platform 3 for example, that allows the platform 3 to receive and process the personalized information. In one embodiment, upon receiving the personalized information the platform 3 may be operable to generate personalized, modifiable executable pathway options (referred to sometimes as simply “pathway options”) that may be used to generate a full or partial pathway towards a goal in combination with one or more associated services described elsewhere herein. Alternatively, the platform 3 may be operable to separately generate the pathway options without regards to an associated service. Conversely, the platform 3 may be operable to provide a particular service described herein to a user without regards to the provisioning of pathway options. It should be understood, however, that the provisioning of pathway options to a user can, in and of itself, be considered an independent and separate service.

In embodiments of the invention, unlike existing systems the systems provided by the present invention are operable to receive a plurality of personalized information from a user. For example, instead of simply receiving generalized information indicating that a student is interested in a 2 or 4 year college, for example, systems provided by the present invention may receive information such as the size of the college a student is interested in attending, its environment (urban, city or country), and geographical location (East coast, West coast, Midwest, etc.,) to name to just few of the many types of personalized information related to an institution. Other types of personalized information, such as a user's academic record (e.g., grades in high school, college), results of standardized tests (e.g. SAT, ACT) and advanced placement (AP) courses completed and test results may be received as well. In sum, a wide variety of personalized information that is specific to a given user may be received by the platform 3 from a user of device 2, 20, 21 or from another source. It should be understood that the personalized information need not be limited to a user's high school or college information. Other types of personalized information include, but are not limited to graduate school, professional, apprenticeship. life-style or health information.

Once received the plurality of personalized information may be used by platform 3 to generate personalized, modifiable executable pathway options towards a user's defined, personal goal and to provide one or more services described herein. The pathway options may be output by the platform 3 and communicated to a user in conjunction with information related to one or more services described herein, or communicated separately. It should be understood that the pathway options comprise electronic signals, such as formatted or unformatted data, and instructions that may be sent to, or exchanged with, a device 2, 20, 21 for example, that allows the device 2, 20, 21 to display or otherwise present information, such as an element, component, pathway, plan, goal, queries, surveys, assessments, milestones, rankings, preferences, values, or some combination of the above to a user on a device 2, 20, 21 using an interface, such as interface 2a in order to allow the user to accept, reject or modify the information, for example. For the sake of brevity, the discussion herein will not always refer to personalized, modifiable executable pathway options. That said, when the description herein refers to an output sent from the platform 3 to a user as part of a service, or when the description herein refers to providing a service to a user, or when the description refers to the operation of platform 3 as part of a service, it should be understood that personalized, modifiable executable pathway options may be generated by the platform 3 as a part of such an output, service or operation and sent or otherwise provided to a user of such a service.

We turn now to a discussion of exemplary, associated services provided by the present invention that may, or may not, be provided in combination or conjunction with pathway options.

In one embodiment, as a part of a Student service the platform 3 may be operable to offer services to a user based on a plurality of personalized information provided by a user. The users may be “affiliated” and “unaffiliated” students, where an affiliated student is a user that is enrolled in an academic or another institution or entity that has been authorized to access services provided by platform 3 while an unaffiliated student is not enrolled in an academic or another institution that has been authorized to access services provided by platform 3. Students may be high school students, college students, international high school students and transfer students, for example. In one embodiment, as a part of the Student service, the platform 3 may be operable to invoke features and functions of one or more additional services, such as an Advisor service, Assessment service, Investigative service, Work Opportunity service, Educational Career (EC) service, EC-GPS service, Marketplace service or a College Application service.

An exemplary Student service may provide a user, such as a student, to interact with other users (students) in order to provide feedback to an institution or a provider of a service as to the effectiveness of a particular service (e.g., is the service helpful or not?? easy to use or not??). Alternatively, or in addition, a Student service may provide a user with the ability to “vote” or “rank” the user's level of satisfaction with a particular service.

In one embodiment a College Application service may offer services to a user based on a plurality of personalized information received from a user. The College Application service may be operable to assist the user in applying to a post-secondary institution, such as a 2 or 4 year college, graduate school or professional school. In one embodiment, as a part of the College Application service the platform 3 may be operable to map personalized information it receives from a user to courses (e.g., a major course of study), potential academic institutions or other entities that offer the so-mapped courses, assist the user in completing the application requirements of each identified institution, and track or otherwise monitor the status of such applications and their related application process (e.g., has the institution received the application? is there any additional information required to complete the application? has the student been accepted into the institution? into a particular part of the institution? (e.g., Engineering School? Arts & Sciences, etc.)). The College Application service may be combined with, or invoke, one or more other services. For example, an Investigative service may be invoked in order to allow a user to investigate the details of one or more academic institutions the user may be interested in applying to using the College Application service. Yet further, an Advisor service may be invoked in order to allow a user to receive advice from an academic advisor during the time period when the user is making use of the College Application service. The College Application service, or one of the services it invokes. or is combined with, may include one or more utilities. For example, a notification utility may be included that generates notifications or messages related to an application's status, an advisor's recommendations or comments, communications from an academic institution about a user's pending or prospective application.

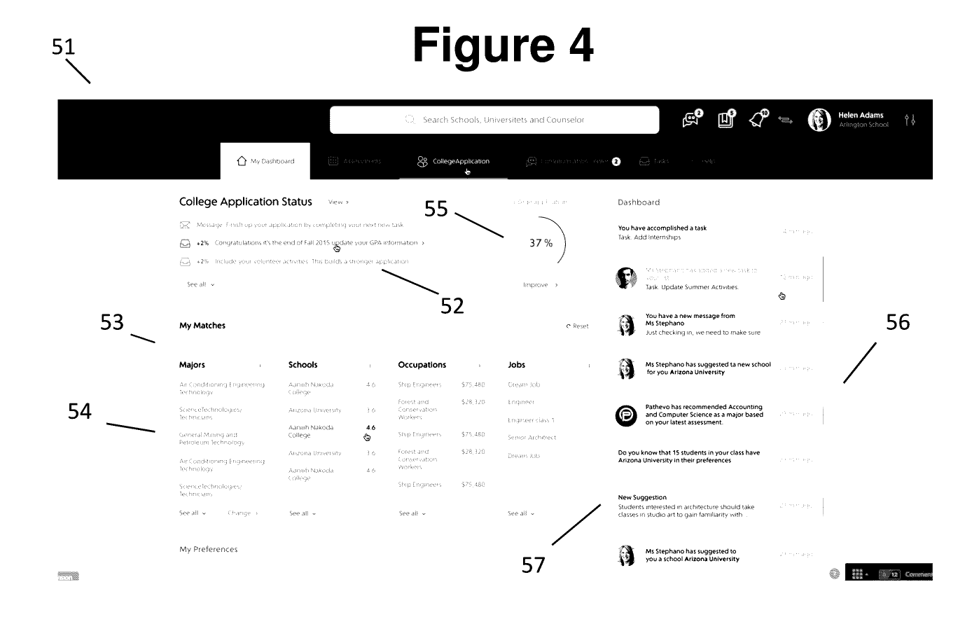

FIG. 4 depicts an exemplary dashboard 51 related to a College Application service that may be generated based on information generated by platforms provided by the present invention described herein, where the information is sent to a user device described herein so that the dashboard 51 can be displayed on an exemplary user interface associated with the user's device.

For example, as shown a user interface may display a dashboard that contains one or more sections, such as a status messaging section 52, match section 53 and related results 54, application completion section 55, task messaging section 56, and advice/advisor-related messaging section 57.

In more detail, a user interface may be operable to display a plurality of different types of messages related to the status of one or more college applications and their associated processes in section 52, for example. One non-limiting type of message may be a reminder for the user to update the user's college application with the user's end-of-semester course grades. Further, the user interface may be operable to display how much of a given college's application process (e.g., related paperwork and information) the user has completed to date in section 55. For example, if a user has only completed 37% of the required process required to complete a given college's application process the user interface may be operable to display this percentage an image or text within section 55.

A user interface may be operable to display certain results 54 as a part of match section 53 that platforms provided by the present invention have generated in response to user input. Some examples of results are “Majors”, “Schools”, “Occupations” and “Jobs” for example.

In more detail platforms provided by the present invention may be operable to determine that specific academic majors (course concentrations), schools (colleges), occupations (e.g., engineering, liberal arts) and jobs (electrician) are the best match for a given user based upon input received by the platform from the user (i.e., they match a user's desires, preferences, etc.). These best matches are then displayed by a user interface as a part of dashboard 51 within section 53 as results 54.

Still further, a user interface may be operable to display a plurality of different types of messages related to tasks the user has completed related to a given college's application process, or should complete in order to fulfill a given college's application process in section 56. For example, one such message may be “Congratulations you have completed the essays!!”. Another message may be a reminder to complete a particular part of the information required by a given college's application process. and a date by which such a task must be completed.

In addition to task related messages, the dashboard 51 may include advice/advisor-related messages within section 57. For example, a user interface may be operable to display a plurality of different types of advice-related messages within section 57 related to the particular college application process the user is presently involved in completing, or related to a new college that an advisor has determined may be of interest to the user, or related to an occupation or job an advisor has determined may be of interest to a user or related to a course or curriculum an advisor believes may be required in order for the user to complete a degree in a particular area (e.g., engineering degree).

A Work Opportunity service may offer services to a user based on a plurality of personalized information provided by a user as well. The information may, for example, comprise a user's non-academic interests, such as a user's interest in learning a vocation or trade (plumbing, electrical work, auto technician, emergency medical training, etc.). Again, it should be understood that the personalized information may take the form of electronic signals, such as formatted or unformatted data, and instructions that may be sent to, or exchanged with, the device 2, 20, 21 and platform 3 for example, that allows the platform 3 to receive and process the personalized information in order to provide a service. Such a service may, or may not, include personalized, modifiable executable pathway options. Upon receiving the information, the platform 3 may be operable to map the user's interests to a potential occupation and an employer that may offer a formal apprenticeship, internship, mentorship, informal training program, or job (collectively referred to as an “opportunity”) related to the user's interests.

Still further, as a part of the Work Opportunity service the platform 3 may be operable to assist the user in completing the application process required by identified employers, training programs, etc., and track or otherwise monitor the status of such applications. Further as a part of the Work Opportunity service the platform 3 may be operable to invoke the features and functions of another service, such as an Advisor service in order to, for example, allow a human or avatar based advisor to assist the user in identifying opportunities, for example.

For example, an exemplary Work Opportunity service may provide a user with the ability to communicate with an advisor (using an Advisor service), and/or a potential employer. Similarly, such a service may enable an advisor to communicate with a potential employer, and vice-versa. Yet further, such a service may provide the user, advisor and/or potential employer with the content of any message exchanged between two or more of them even if the user, advisor or employer was not involved in the exchange. For example, a message originally exchanged between a user and an advisor may be subsequently sent to an employer or otherwise be made available to the employer via a web based browser.

Still further, a user, advisor or potential employer may be sent information about an opportunity. The information sent to each individual may vary, however. For example, a user may be sent information, or may otherwise be granted access to view a list of opportunities originated by an employer via a user device's web based browser, for example. Conversely, an employer may be able to view those users who have accessed the list of opportunities. In one embodiment, only the employer is provided with the identity of users that access such opportunities (i.e., a user does not receive, is not given access to, and does not view information about other users).

An Advisor service provided by the present invention may offer “local” or “global” services to a user based on a plurality of personalized information provided by a user, and information provided by an advisor.

In more detail, from a user's perspective one example of a local service may involve an advisor that is affiliated with the institution the user (student) attends or expects to attend while a “global” service may involve an advisor that is unaffiliated with the institution the user attends or plans to attend. From the advisor's perspective, he or she may be a part of both types of services. That is, a particular advisor may sometimes provide advice or otherwise exchange communications with a user that attends or expects to attend an institution the advisor is also affiliated with (local provide advice or otherwise exchange communications with a user that does not attend or does not expect to attend an institution the advisor is affiliated with, for example.

As a part of a local or global service the platform 3 may be operable to connect an advisor with a user (and vice-versa) via an exchange of communications (e.g., notifications) that utilizes platform 3, device 2, 20, 21 in order to allow the advisor and user to communicate with one another.

As with the other services described herein, the Advisor service may be combined with, or invoke other services. For example, the Advisor service may invoke the Work Opportunity service in order to involve a potential employer in communications with an advisor and user.

In embodiments of the invention, an advisor may be a living person, an avatar or a virtual reality advisor for example.

As a part of an Advisor service the platform 3 may be operable to retrieve from memory, and present to a user, a stored list of advisors, their qualifications, experience, rankings, expertise, cost (if any) and preferences. Conversely, the platform 3 may be operable to retrieve from memory or otherwise in real-time or near real-time and present to an advisor (e.g., transmit or otherwise send) the identity of one or more users that require advice, along with personal information about an identified user along with a user profile that the user has authorized may be disclosed to a potential advisor.

In embodiments of the invention, the platform 3 may be operable to allow a user to select an advisor, or conversely, to allow an advisor to select or otherwise advertise to a user the advisor's interest in advising the user. Yet further, as a part of the Advisor service, the platform 3 may be operable to invoke features and functions of another service and combine such features and functions with the features and functions of the Advisor service.

Still further, as part of an Advisor service the advisor may review the present plan, or pathway that have been previously generated by the user and platform 4. Upon review, the Advisor service may provide an exchange of communications (e.g., notifications, messages) between the advisor and user concerning, for example the advisor's/user's suggested modifications to a plan or pathway, acceptance/rejection of the plan or pathway by the advisor/user, or an action the advisor/user directs the user/advisor to fulfill.

As part of a Pre-College service the platform 3 may be operable to invoke the features and functions of one or more of the services mentioned herein, for example.

As part of an Assessment service the platform 3 may be operable to present a plurality of assessment services, such as Interest Profiler (IP), personal globe inventory (PGI) and STEM assessments to a user. In one embodiment, these assessment services may be interest based and can provide a user with a list of recommended major areas of study and/or career occupations based on the interests of the user. Such a service may be a freemium, app, or subscription based service. The platform 3 may be further operable to store the results of an assessment that is part of an assessment service completed by a user in memory or a database 3c that is a part of the platform 3 or in a third party database.

In a further embodiment, the platform 3 may be operable to provide one or more additional assessment services to a user that include assessments based on aptitude measurements, learning preferences, personality assessments (e.g., Myers-Briggs), placement tests (e.g., COMPASS) or some combination of these and other types of assessments. The platform 3 may be further operable to store the results of one or more of these assessments completed by a user in memory or a database 3c that is a part of the platform 3 or in a third party database.

As a part of a STEM assessment service the platform 3 may be operable to provide data (formatted and unformatted), instructions and signaling to a user device 2, 20, 21 to allow the user device to generate and display a customized user interface that includes customized user experience features.

In embodiments of the invention, the platform 3 may be operable to include an art (e.g., visual, audio, graphical, performing arts) assessment as a part of the STEM assessment service (resulting in a STEAM service).

As part of an Administrator service the platform 3 may be operable to receive information from a device 20 associated with an administrator (e.g., of an academic institution) that identifies a user or users (e.g., affiliated users) that have accessed a service provided by platform 3, for example. Prior to accessing an Administrator service, an administrator may be required to exchange communications with platform 3 (e.g., section 3a) or another third party registrar using device 20 to complete an authentication and registration process in order to gain access to the Administrator service.

An exemplary Administrator service may provide an administrator with the ability to add/delete users to/from one or more of the other services described herein, view historical data concerning users of one or more services described herein or other services used by the administrator, and generate reports related to the one or more services described herein, for example.

Still further, as a part of an Administrator service the platform 3 may be operable to provide the administrator (e.g., device 20) with information that allows the administrator to monitor the activity of affiliated users (e.g., students) that have accessed a service, such as the Work Opportunity, or College Application service, for example. Further, such a service may provide an administrator with the ability to monitor communications exchanged between a user (e.g., student) an advisor or potential employer in order to insure that such communications abide by the laws, rules, regulations and ethics of a given institution, state or federal agency as well as safeguard the physical and emotional well being of the user.

An Administrator service may be provided to an institution or another entity on a free or freemium basis when the institution has subscribed to another service or made a subscription service available to affiliated users.

The services described above and elsewhere herein are just a few of the many services that may be provided to the user as standalone services or in combination with providing pathways towards a goal. Other exemplary services are a “marketplace” service that enables users (e.g., students, prospective students) seeking admission to an academic institution or seeking aid from a private or public entity to present their credentials, qualifications, etc., (via their self-reported qualifications) to members of a plurality of institutions or members of such entities (e.g., organizations that provide scholarships, financial aid) that are looking to admit and/or award resource support (e.g., scholarships) to the user in order to allow the user to pursue her next educational goal, for example. Alternatively, or optionally, such a service may also provide members of an institution or entity that are looking for talented users who will help continue to uphold the institution's or entity's traditions to present themselves (via their self-reported profile) to users (e.g., students and prospective students) they intend to admit and/or award resources to, to support the institution or entity's continuing mission of excellence. By presenting themselves to each other in this manner allows a user to select the institution or entity that provides the user with the best offer (e.g. most financial aid), while conversely allowing a member to attract users (e.g., students) that the member believes is the best match with for his institution or entity.

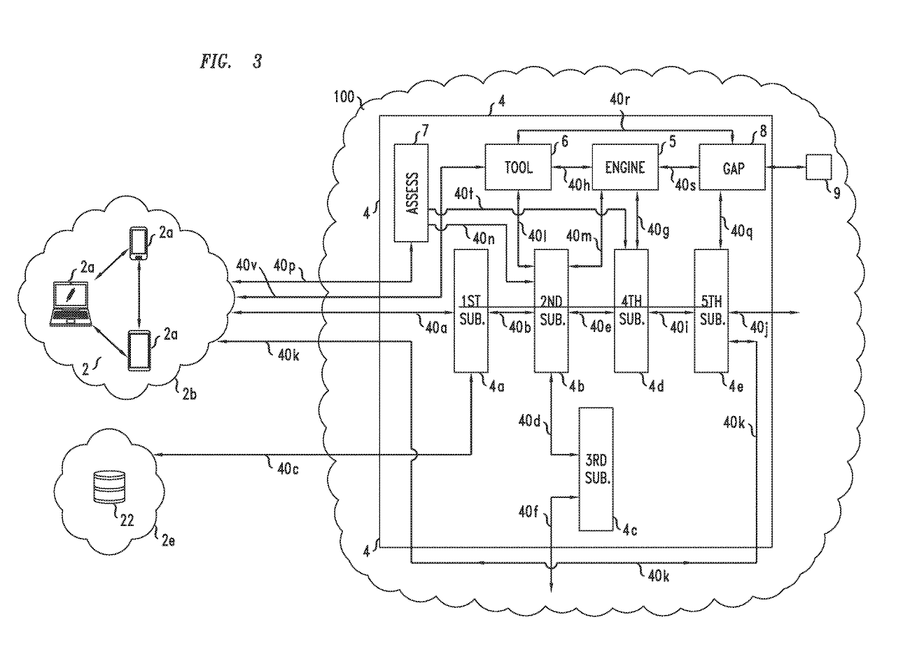

Referring now to FIG. 3 there is depicted a block diagram of an exemplary platform 4 used as part of a system 1 to provide services to a user so that the user can, for example, receive and help generate personalized, modifiable pathway(s) towards a goal, such as an educational, career, health, or life-style goal, for example. In one embodiment the platform 4 may be operable to provide the features and functions required by a partial feature platform 300, a full featured platform 3000 and or both platforms. Thus, platform 4 can be said to support the provisioning of one or more free or “freemium” services, subscription services or some combination of such types of services.

Platform 4 may comprise one or more hardware electronic subsystems and sections that include one or more computing devices (e.g., one or more hardware servers, processors, memories, databases) that are specially programmed to execute, or to be controlled by, instructions stored in memory and/or to access data stored in specialized memories to provide the services selected by a user by completing the features and functions associated with such services.

For ease of explanation the platform 4 has been divided into a number of subsystems and sections though it should be realized that a number of the subsystems and sections may be combined into fewer sections or further broken down into additional sections. Yet further, it should be understood that one or more features and functions of a subsystem or section may be distributed to one or more additional subsystems or sections. That is to say, a given feature or function may be completed using one subsystem or section exclusively or by using more than one section. Further, the phrases “subsystem” and “section” may be used interchangeably herein.

Still further, while the description herein focuses on the inventive features, functions and methods related to the present invention it should be understood that the platform 4 may include, and typically will include, additional hardware and software (including firmware) necessary for its operation. Because such hardware and software is well known, however, little if any description of such additional hardware and software or their operation will be included herein for the sake of brevity.

It should be noted that FIG. 3 does not include a depiction of a communications and administrative section or an integrator section as in FIG. 1. This is also done for the sake of brevity. It should be understood that in one embodiment a communications and administrative section, an integrator section or some combination or variation of the two types of sections may be provided between the platform 4 and device 2. Further, though not shown in FIG. 3, devices 20, 21 may also be connected to platform 4.

In one embodiment the platform 4 may include five subsystems 4a through 4e, referred to herein as first subsystem 4a, second subsystem 4b, third subsystem 4c, fourth subsystem 4d and fifth subsystem 4e, respectively. Again, it should be understood that the subsystems 4a-4e may be implemented as five separate subsystems, or one or more of the subsystems 4a-4e may be combined or integrated to form fewer than five subsystems. Alternatively, the five subsystems 4a-4e may be further divided or segmented into more than five subsystems.

Each of the subsystems 4a-4e, whether separate, divided, combined or segmented may comprise one or more processors specially designed and programmed to complete the features and functions described herein by, for example, accessing instructions stored in memory and/or data stored in memory or a database. It should be understood that all of the subsystems 4a-4e need not include a processor, or a memory.

It should be understood that, as used herein, the designations “first”, “second”, “third”, “fourth” or “fifth” is purely to distinguish one app, subsystem, section, etc., from another and does not indicate an importance, priority or status. In fact, the apps, subsystems and sections could be re-designated (i.e., re-numbered) and it would not affect the operation of the system 1.

We turn now to a description of the subsystems 4a-4e that may be included within the platform 4 in order to provide services to a user and/or generate personalized, modifiable pathway(s) and pathway options towards a goal.

In one embodiment the first subsystem 4a may be operable to receive personalized information from a user that may be input via connection 40a. Such information may include a plurality of information related to a given service the user has been authorized to access and receive (via an authentication/registration process, for example), or may be related to the generation of a modifiable pathway. Exemplary non-limiting examples of the latter are starting points, milestones or goals, and modifications to such starting points, milestones and goals as well as modifications to previously generated personalized, modifiable pathway options. Some non-limiting examples of a “milestone” in the educational area are a high school diploma or equivalent, or a vocational, associate's, bachelor's, master's, doctoral or professional certification degree in an academic disciplinary area. It should be understood that the educational area is only one of many areas covered by the scope of the present invention.

It should be understood that the exact type of personalized information that is input by a user will depend upon the services the user is interested in.

Generally, the information may be input by a user of device 2, 20, 21 via, for example, a user interface, browser or an app. Section 4a may be operable to receive the personalized information and output the personalized information via connection 40b to a second subsystem 4b. Alternatively, the first subsystem 4a may generate some of the personalized information (including the starting points, milestones or goals) from data stored in a memory or database a part of platform 3 or stored or elsewhere. For example, in an alternative embodiment the first subsystem 4a may be operable to receive a plurality of personalized information via connection 40c from a profile database 22, where the information may comprise, for example, attributes, user profiles and assessment results, college application status information, work opportunity status information, etc. Thereafter, the first subsystem 4a may be operable to generate the personalized information based at least on the information received from the database 22, and then output the so-generated personalized information to the second subsystem 4b.

The profile database 22 may be a part of the platform 4, a part of the network 2e, or may be distributed among some combination of platform 4, network 2e and other devices (not shown in FIG. 3) or may be part of an app.

Continuing, the second subsystem 4b may be operable to receive the personalized information from the first subsystem 4a, and then generate a plurality of initial, potentially viable pathway components and elements based on the received personalized information. Some non-limiting examples of an “element” in the educational area are curriculum rules, academic course and curriculum tasks while a non-limiting exemplary example of a component is an academic course listing and associated requirements of an academic semester or quarter. Again, it should be understood that the educational area is only one of many areas covered by the scope of the present invention.

The plurality of initial, potentially viable pathway components and elements may be stored, for example, in the second subsystem 4b, in another section of platform 4 (e.g., database 3c), in a separate memory or database altogether, distributively stored at one or more of such subsystems or stored using some combination of the above. As illustrated in FIG. 3, the second subsystem 4b may be further operable to receive a plurality of user constraints from a third subsystem 4c via connection 40d. Some non-limiting examples of user constraints are user preferences, filters and limiters, for example.

Some examples of a “limiter” are SAT scores, and other test results while some examples of filters are a user's desire to attend a college that is in a small city, large city or urban area (so-called “environmental” factors). In embodiments a filter may incorporate a number of user preferences other than environmental factors, such as the desirability to attend a college that has a popular sports team, has an active social life, is nearby a popular music community, or includes certain services (e.g., hair salons, shopping areas, etc.).

Accordingly, unlike existing systems, systems provided by the present invention may take into account a plurality of personalized information that may be further modified by a plurality of constraints, both real-time and non-real time constraints (i.e., those constraints that have been stored and now applied by the platform 3 or those that have just been received by the platform 3). The ability to modify a plurality of personalized information is believed to be unique. Heretofore, existing systems may have been able to generate some kind of educational or career plan, but such plans have been static. That is, such plans are not modifiable at all, or if they are modifiable, it requires the user to create a wholly separate plan altogether. Further, it is believed that such existing plans cannot be modified by a large number of constraints.

Upon receiving the constraints the second subsystem 4b may be operable to apply the received constraints to the initial, potentially viable pathway components and elements. The application of the constraints to the initial, potentially viable pathway components and elements results in the generation of a reduced set of potentially viable pathway components and elements. That is, as denoted by its name, “constraints” modify the initial, potentially viable pathway components and elements by constraining or further focusing the initial, potentially viable pathway components and elements. Thereafter, the reduced set of potentially viable pathway components and elements (i.e., modified, initial, potentially viable pathway components and elements) may be output to the fourth subsystem 4d via connection 40e, or stored, for example, in the second subsystem 4b, in another section of platform 4 (e.g., database 3c), in a separate memory or database altogether, distributively stored by such subsystems, or using some combination of such subsystems.

Backtracking somewhat, prior to forwarding the user constraints to the second subsystem 4b, the third subsystem 4c may be operable to receive and store the user constraints (e.g., preferences, filters and limiters) that are received via connection 40f from a user of device 20, 21 for example.

At this point the platform 4 has generated a reduced set of potentially viable pathway components and elements based mainly on information originated or selected by a user, so-called “user constraints”. For example, if the user's goal is to determine an academic plan, the user may have already selected the type of degree she desires to obtain, the types of courses she desires to study, the geographic location of the school she desires to attend, the size of the school she desires to attend, among other constraints or personalized information.

To test whether this reduced set of potentially viable pathway components and elements are practically achievable, additional information may be (typically is) needed and additional analyses may be (typically is) required. For example, in the academic setting, information about the specific academic, course and curricula rules and constraints applicable to a selected school or institution may be required. Such constraints will be referred to as “organic rules” and “organic constraints”. Accordingly, unlike existing systems, systems provided by the present invention may take into account a plurality of personalized information that may be further modified by a plurality of both user and organic constraints (both real-time and non-real time). The ability to further modify a plurality of personalized information using both user and organic constraints is believed to be unique.

Continuing now with a description of the platform 4 shown in FIG. 3, as noted above the second subsystem 4b may output the reduced set of potentially viable pathway components to the fourth subsystem 4d. In an embodiment, the fourth subsystem 4d may be operable to receive the reduced set of potentially viable pathway components and elements and, in addition, organic rules and organic constraints from a dynamic rules engine 5 via connection 40g. In one embodiment, the engine 5 may be operable to analyze, compute and compare (collectively “manage”) relationships between pathway components and elements based on on-demand element and component combinations and equivalences the engine 5 receives, for example, via connection 40h from an indexed, multi-dimensional element equivalence identification and comparison tool 6 (“tool”) that is operable to so generate the on-demand element and component combinations and equivalences.

The fourth subsystem 4d may be operable to apply the received organic rules, organic constraints to the reduced set of potentially viable pathway components in order to generate (or regenerate if this is not the first iteration) permutations and combinations of viable pathway components and elements that may be used to further modify the reduced set of potentially viable pathway components and elements to form a set of generated (or re-generated), generalized executable pathways.

Upon forming the generalized executable pathways, the fourth subsystem 4d may be operable to output such pathways to the fifth subsystem 4e via connection 40i.

Before continuing it should be noted that the on demand element and component combinations and equivalences that are sent to the engine 5 may be sent to fourth subsystem 4d first, or alternatively, sent directly to the engine 5.

In one embodiment, the fifth subsystem 4e may be operable to receive the generalized executable pathways, and, in addition a plurality of additional personalized information via connection 40j from other sections within the platform 4, from the profile database 22, or from other sources (not shown in FIG. 3) or from some combination of the three.

Some non-limiting examples of additional personalized information are: profile information, assessment information or user preference information. Upon receiving the pathways and information, the fifth subsystem 4e may be operable to generate and/or regenerate one or more personalized, modifiable executable pathway options towards a defined goal based at least on the received generalized executable pathways and user-specific information. If desired, the fifth subsystem 4e may then output the pathway options as a part of one or more associated services described elsewhere herein, or may output the pathway options separately. The pathway options may be output to a user of device 2, 20, 21 to name just a few of the many destinations that may receive the outputted pathway options. The options may be output to device 2 via connection 40k directly using an app, for example, or, alternatively via a combination of a communications and administrative section and an integrator section using an app, for example.

In sum, because systems provided by the present invention may take into account a plurality of personalized information that may be further modified it can be said that the present invention provides exemplary platforms that can be used to generate personalized, modifiable executable pathway options that can be made a part of a number of services that are offered to a user described elsewhere herein.

In the description above it was noted that the fourth subsystem 4d may receive organic rules and organic constraints from a dynamic rules section or engine 5 (referred to as “engine”), and, further, that engine 5 may receive on on-demand element and component combinations and equivalences from tool 6.

We now turn to a discussion of exemplary embodiments of such an engine 5 and tool 6.

Turning first to a discussion of an exemplary tool 6, in an embodiment of the invention the tool 6 may comprise an element and component articulator section that is operable to compare element and components (e.g., courses, curriculums, syllabi) of one institution to those of another institution, to name just one of the many functions that may be completed by the articulator section. Such a comparison is typically required when a student wishes to transfer from one academic institution to another.

In more detail, in one embodiment the tool 6 may be operable to process and store element and components in permutated pairs of pathway elements and pathway components, and associate or assign these pairs of stored elements and pairs of stored components with mutual equivalence measures. Again, one example of an element is an academic course of instruction and curriculum tasks, while examples of a component are an academic course listing and associated requirements of an academic semester or quarter. The association or assignment of mutual equivalence measures is a step that may be used in a method for determining whether a course offered by one institution is equivalent to a course offered by another. It should be noted that such an association or assignment may be asymmetrical or “one way”. That is, though a particular course offered by a first institution may be accepted by a second institution (and, therefore, an associated equivalence exists or is assigned), a similarly named course (but dissimilar otherwise) offered by the second institution may not be accepted by the first institution because, though similarly named, the courses may differ in difficulty, scope, prerequisites, etc. (and, therefore, no associated equivalence exists or is assigned).

In more detail, the tool 6 may be operable to receive initial, potentially viable pathway elements or components from the second subsystem 4b via connection 40L, and retrieve a pathway element or component from an associated or separate memory or a database. The tool 6 may also receive information from the engine 5 (discussed below). The memory or database may, for example, be part of the tool 6, a part of another section of the platform 4, be a separate memory or database, be distributed among such devices/locations or be a part of some combination of such devices/locations. The tool 6 may also be operable to receive a single component or element from the device 2, 20, 21. Thereafter, the tool 6 may be operable to compare one of the received elements or components with the retrieved element or component, where the received and retrieved elements form a pair, or the received and retrieved components form a pair, in order to determine mutual subject matter equivalence measures and attributes for the formed pairs. Accordingly, the tool 6 may, thereafter, be operable to determine the mutual subject matter equivalence measures and attributes for either one of the formed pairs based on a comparison closest to what the user desires, for example.

Upon determining such mutual subject matter equivalence measures and attributes, the tool 6 may be operable to assign a two-dimensional equivalence measure to each formed pair based on their determined mutual subject matter equivalence measures and attributes, and store (or re-store) the formed element and the component pairs, along with their associated equivalence measures as equivalence attributes in a memory or database that may be (i) part of the tool 6, (ii) a part of another section of the platform 4, (iii) in a separate memory or database (not shown in FIG. 4), (iv) in a distributed manner at such devices/locations, or (v) at some combination of such devices/locations. The assignment of a two-dimensional equivalence measure, and storage (or re-storage) of formed element and component pairs, along with their associated equivalence measures as equivalence attributes are steps that may be used in a method for determining whether a course offered by one institution is equivalent to a course offered by another.

We now turn to a discussion of an exemplary dynamic rules engine. In one embodiment a dynamic rules engine 5 may be operable to modify a course in a curriculum (in the education embodiment of the invention). In embodiments of the invention, after a modification to a curriculum (e.g., course modifications), the engine 5 may be operable to insure that all constraints are met so that the modification does not violate one or more rules (e.g., the modifications to a course or curriculum do not violate the rules of an academic institution).

In one embodiment the engine 5 may be operable to receive a reduced set of potentially viable pathway elements and components from the second subsystem 4b via connection 40m along with their associated equivalences and attributes from the comparison tool 6 via connection 40h. Upon receiving such information, the engine 5 may be operable to generate governing relations and associated elements and components as generalized, executable pathway elements and components. Such relations and associated elements and components may be used to detect, or may detect, whether a proposed modification to a course (element) or curriculum (component) violates one or more rules. Thereafter, the engine 5 may be operable to output the generalized, executable pathway elements and components 30 to the fourth subsystem 4d via connection 40g or to the tool 6 via connection 40h.

Some examples of generalized, executable pathway elements and components are courses and curricula, that comply with (or fail to comply with) a set of rules, respectively.

It should be understood that the engine 5 may be a configured as a part of the platform 4, another part of system 1 or may be a standalone system.

Regardless of the configuration, the engine 5 may be operable to detect whether a modification in a course or curriculum (in the education embodiment of the invention) is acceptable or not. In embodiments of the invention, after a modification to a curriculum (e.g., course modifications), the engine 5 may be operable to insure that all constraints are met so that the modification does not violate one or more rules, such as: (i) the modification does not result in less than the minimum number of credits allowed by an institution per time period (semester, term); (ii) the modification does not result in more than the maximum number of credits allowed by an institution per time period (semester, term); (iii) the modification results in an associated course being taken within the proper year as required by an institution; (iv) a course is taken in its proper order, for example, after a certain number of credits have been accumulated or before a certain number of credits have been accumulated; (v) insures that all necessary prerequisites have been taken before the proposed course (i.e., modification); (vi) insures all co-requisites are concurrently scheduled; (vii) as needed, insures that the proper mix of electives are valid; (viii) insures the proper mix of prescribed courses are met (i.e., there are choices to make even in core requirements).

The engine 5 may also be operable to track or monitor a plurality of personalized information for a user, such as: the user's cumulative grade point average (gpa) (including transfer credits if used by the institution), the user's gpa for major courses; or the user's gpa for previous years or for a certain number of terms or credits (i.e., some institutions require a certain minimum gpa for the previous 2 terms or year). Similarly, the engine 5 may be operable to provide the user with a plurality of alerts or “flags”, such as: a flag indicating if the user's gpa is within 20% above the minimum required for the previous year; a flag indicating if the user's gpa is within 20% above the minimum required for graduation at a given institution; a flag indicating if the user's gpa is within 20% of being an honor student; or a flag indicating if the user's gpa is above a honor student requirement at a given institution, to name just a few of the many exemplary flags that may be generated and provided to a user.

In accordance with embodiments of the invention, the engine 5 may additionally provide the following to a user: information (gpa) being tracked, and notifications regarding whether or not a modification has met one or more constraints (e.g., rules).

The alerts, flags, information and notifications (among other types of information) may be formatted by the platform 3 and then sent to a user device, such as device 2.

In one embodiment, an app may be stored on the device 2 (or another device) and may be operable to exchange communications with the platform 3 in order to allow the app running on device 2 to receive and further modify or manipulate (e.g., format) the received information for display by an interface 2a, for example.

For example, in one embodiment, a user's present, proposed or modified curriculum may be displayed in a sequential time period (per term, semester). Within each time period the courses making up the curriculum for that time period may be listed along with the number of credits associated with each course as well as the grade received by the user for the particular course during that time period. Following the listing of courses, the information may be formatted to allow the user interface to display the number of credits earned for the given time period, the cumulative number of credits earned over all time periods (terms, semesters), the user's gpa for a given time period (the present one, or another one) and a cumulative gpa.

In embodiments of the invention, information related to the curriculum, course, credits and gpa for each subsequent or previous time period may be similarly formatted and displayed by an interface 2a that is part of device 2, 20, 21.

In alternative embodiments, some or all of the information to be displayed by the user on an interface 2a may be input by a user and received by the device 2, 20, 21 (and associated, stored app) instead of being provided by the platform 3. For example, in one embodiment, a user may input the grades he or she earned for a given course during a given time period. In the event courses that may be taken well into the future are listed (e.g., an entire 4 year syllabus may be listed) an indication that such future courses have not been completed may be indicated by displaying an “N/A” for “not applicable” instead of a grade for such courses.

In embodiments of the invention, an interface 2a and associated app (or other stored instructions) may be operable, in conjunction with the operating system of the device and the display, to allow the user to select (e.g., right click on) a location within any displayed time period in order to edit, add or delete information within the time period. Upon selecting a particular location within a time period, the interface 2a may be operable to display one or more drop down menus. In an exemplary embodiment, one such menu may include the following: a selectable message indicating a course can be added to the time period (i.e., at a location within the displayed time period); information identifying when a course has been selected (e.g., highlighted information, or a pop-up or secondary (smaller) display or menu superimposed within or overlaying the larger display); information instructing the user to enter a number, letter, icon or some combination of the three associated with a given course. Additionally, the interface 2a may be operable to display an empty box or location that allows a user to enter one or more of the following types of information: department, user's year of education (e.g., freshman, sophomore, etc.), the title of a course or a keyword related to a title of a course, or just descriptive keywords. Once such information is entered, the interface 2a in conjunction with the app and platform 3 (e.g., communication exchanges with platform 3) may be operable to display a list of courses that match the information input by the user. Thereafter, the user may be able to select (e.g., click on) any listed course. Upon selecting a listed course, the interface may be operable (in conjunction with the app, and platform 3) display a description of a selected course, for example, in order to allow the user to determine whether the course indeed satisfies his or her criteria. If so, the user may complete an action (e.g., drag and drop, double-click) in order to add the selected course to the curriculum for a given time period (e.g., the present time period if the course was left off the original listing or future time period for planning purposes).

In additional embodiments a user can right click, or otherwise select, on any course displayed by an interface 2a. Thereafter, the interface 2a may be operable to display a menu that may include one or more of the following messages: add a grade, delete a course, replace a course, display a description of the course, and/or change the number of credits (if this is changed manually by a user, an asterisk or another indicator may appear next to the number of credits).

Still further, the interface 2a may allow the user to drag or otherwise select a course name that is displayed as a part of one time period in a curriculum and move the course to another time period within the same curriculum. Once moved, the interface may remove the now-moved course from the original time period (i.e., the course is moved from one location or area on the display to another).

The various information that may be displayed on the interface 2a and the information making up such a display may be considered personalized, modifiable and executable pathway options sent from platform 3.

As noted before, the engine 5 may be used to apply certain constraints to any changes. Thus, in embodiments of the invention, each of the changes input by the user may be sent to the platform 3 and then on to engine 5. Thereafter, engine 5 may apply one or more of the constraints discussed above or additional constraints in order to insure that all of the modifications do not violate a constraint. In embodiments of the invention, if a modification violates a constraint then a message (notification) may be generated by the engine 5 and sent to the user via platform 3, for example. In embodiments of the invention, engine 5 may also generate instructions prohibiting the interface 2a from displaying one or more of the menus described above. The instructions may be sent to the device 2 via platform 3, for example.

The interface 2a may also be operable to display a separate icon or indicator that, when selected by a user, initiates a search of available courses offered by an institution that have been stored or otherwise accessed by platform 3, The information associated with the selected icon that is sent to the platform 3 may include personalized information. In embodiments of the invention, the interface 2a, in conjunction with the stored app and platform 3 may be operable to receive the following type of search criteria: department, user's year of education (e.g., freshman, sophomore, etc.), the title of a course or a keyword related to a title of a course, or just descriptive keywords. This search criteria may include, or be considered, personalized information.

Now that we have discussed additional details of the engine 5 and tool 6 we present additional embodiments of sections 4a through 4e. For example, in an alternative embodiment, the fourth subsystem 4d may be further operable to receive the generalized, executable pathway elements and components from the engine 5, and then generate generalized, executable pathways based on the received elements and components.

In addition to subsystems 4a-4e, the platform 4 may also include a user assessment section 7. In one embodiment, the user assessment section 7 may be operable to provide an assessment service (e.g., the Assessment service described elsewhere herein) that provides a plurality of assessments, such as an: IP assessment, PGI assessment, STEM/STEAM assessment, aptitude based measurement assessment, learning preference based assessment, personality assessments (e.g., Myers-Briggs), placement tests (e.g., COMPASS) or some combination of these and other types of assessments. For example, the platform 3 may be operable to send one or more formatted assessments to the interface 2a. Thereafter, the user of device 2 may be operable to complete the assessment(s) displayed or otherwise depicted by interface 2a and send the completed assessment to the platform 3, or to a third party or both.

Thereafter, the assessment section 7 may be operable to apply the results of a given assessment as described below or elsewhere herein. For example, section may be operable to apply the results of a given assessment to potentially viable pathway elements and components it receives from subsystem 4b via connection 40n or to generalized executable pathways from subsystem 4d via pathway 40T. By applying the results, section 7 may be operable to modify the potentially viable pathway elements and components or executable pathways in order to reduce the number of received potentially viable pathway elements and components or generalized executable pathways.

Still further, the user assessment section 7 may be operable to generate individual user parameters like aptitude, skills, academic major interests, occupation interests, and academic and/or career parameter preferences (from the results of an assessment, for example) that serve as user constraints to reduce the number of potentially viable pathway elements and components or generalized executable pathways. For example, when section 7 applies constraints to a user's target starting, ending or intermediate milestones that the section 7 has received, for example, from the user via an app on device 2 and connection 40p, section 7 may generate modified, focused pathways that are most compatible with the user.

The assessment section 7 may comprise a pathway filtering section operable to apply user assessment results, limiters, filters, user preferences and/or user profile attributes (again, from the results of an assessment, for example) to the potentially viable pathway elements and components or generalized executable pathways. Upon applying the results, the section 7 may be operable to further modify and reduce the number of potentially viable pathway elements and components or executable pathways in order to reduce the number of potentially viable pathway elements and components to those that are compatible with assessment results based on one or more of at least: a preference assessment, an interest assessment, an aptitude assessment, a vocational assessment, an academic assessment and a personality assessment. Alternatively, the filtering section may be a part of another section of the platform 4 or distributed among sections of the platform 4, including the assessment section 7.

Accordingly, unlike existing systems, systems provided by the present invention may take into account a plurality of personalized information that may be further modified by a plurality of assessment results, limiters, filters, user preferences and/or user profile attributes. The ability to modify a plurality of personalized information using assessment results, limiters, filters, user preferences and/or user profile attributes is believed to be unique.

In addition to the assessment section 7, the platform 4 may comprise a gap analysis section 8. In one embodiment, such a section may comprise post-processing electronic circuitry, and may be operable to: (i) receive the one or more personalized executable pathway options from the fifth subsystem 4e via connection 40q, (ii) identify a component or element that is not being executed correctly, (iii) identify one or more follow-on, next components or elements that will be ineligible to be executed, based on the identified, incorrectly executed components or elements for the user, (iv) output the identified incorrectly executed components or elements to the comparison tool 6 via connection 40r so that the tool 6 may generate alternative element equivalents, for example, (v) output the alternative element equivalents to the dynamic rules engine 5 via connection 40s so that the engine 5 may regenerate personalized, modifiable executable pathway options as replacements for the component or elements that are not being executed correctly, and (vi) output the one or more personalized, modifiable executable pathway options to a user repository 9 (e.g., memory). The user repository 9 may be a part of the platform 4, user device 2, 20, 21 database 22, another device (not shown in FIG. 4), or distributed over such devices/locations for example.

In more detail, section 8 may help identify inadequacies in a user's ability (or eligibility) to complete subsequent path components necessary for progress towards a user's designated goal. For example, upon receiving information (e.g., a proposed executable pathway option), section 8 may be operable to identify whether a particular personalized executable pathway option is missing required components or elements necessary for being eligible for a subsequent pathway component or element, and thus for completing that subsequent component or element (e.g., does the grade a student received in a particular course make the student ineligible for a subsequent course in the curriculum?).

For example, the section 8 may determine that a “gap” exists due to the absence of a prerequisite course that needs to be taken during the current path component or element in order to be eligible to take a course that is required for graduation after the next component or element. If path components or elements are determined to be missing or inadequate, section 8 may be further operable to complete the functions discussed above. For example, section 8 may generate additional or new personalized, modifiable executable pathway options that may include recommendations on how to mitigate or lessen the negative effects of a missing pathway element or component, for example.

The ability to identify missing elements in a component (e.g., a missing course in a semester) in a timely fashion (e.g., as soon as a “gap” or missing item is identified) without human intervention (i.e., electronically by platform 3) is believed to be unique.

While exemplary embodiments have been shown and described herein, it should be understood that variations of the disclosed embodiments may be made without departing from the spirit and scope of the claims that follow.

1. A system for providing a pathway towards a goal comprising:
a hardware platform comprising one or more devices operable to,
generate one or more personalized, modifiable and executable academic or career pathway options based on personalized information provided by an individual that comprises the individual's desires, likes/dislikes, and interests,
apply results of an academic or career assessment, selected from an Interest Profiler, personal globe inventory, STEM or STEAM assessment, completed by the individual and provided to the platform to reduce the number of pathway options,
detect a modification in the personalized, modifiable executable pathway options, and insure that all constraints are met so that the modification does not violate one or more rules; and
output the personalized, modifiable and executable pathway options.

2. The system as in claim 1 wherein the platform is further operable to output the personalized, modifiable and executable pathway options in combination with a student-related service.

3. The system as in claim 1 wherein the platform is further operable to output the personalized, modifiable and executable pathway options in combination with a college application-related service.

4. The system as in claim 1 wherein the platform is further operable to output the personalized, modifiable and pathway options in combination with an advisor-related service.

5. The system as in claim 1 wherein the platform is further operable to output the personalized, modifiable and executable pathway options in combination with an employer-related service.

6. The system as in claim 1 wherein the platform is further operable to output the personalized, modifiable and executable pathway options in combination with one or more assessment related services.

7. The system as in claim 1 wherein the platform is further operable to output the personalized, modifiable and executable pathway options in combination with an investigative service.

8. The system as in claim 1 wherein the platform is further operable to output the personalized, modifiable and executable pathway options in combination with a work opportunity service.

9. The system as in claim 1 further comprising a user device operable to receive the personalized, modifiable and executable pathway options and send the personalized information to the platform.

10. The system as in claim 9 wherein the user device is a wireless or wired device.

11. (canceled)

12. The system as in claim 11 wherein an element comprises an academic course of instruction and a component comprises an academic course listing and associated requirements of an academic semester or quarter.

13. The system as in claim 9 wherein the user device comprises a user interface for communicating with the platform.

14. The system as in claim 11 wherein the constraints comprise user constraints and organic rules and organic constraints.

15. The system as in claim 14 wherein the organic constraints comprise constraints applicable to a selected academic school or institution.

16. The system as in claim 15 wherein the organic constraints further comprise academic course and curricula rules and constraints.

17. The system as in claim 1 wherein the platform is further operable to apply the results of the selected assessment to a number of potentially viable pathway elements and components to modify and reduce the number of potentially viable pathway elements and components and output modified, personalized executable pathway options associated with an assessment.

18. The system as in claim 1 wherein the platform is further operable to:
receive the one or more personalized executable pathway options;
identify a component or element that is not being executed correctly;
identify one or more follow-on, next components or elements that will be ineligible to be executed, based on the identified, incorrectly executed components or elements for the user; and
output alternative element equivalents to a dynamic rules section to regenerate personalized executable pathway options as replacement for the component or elements that are not being executed correctly.

19. A system for providing a pathway towards a goal comprising:
a hardware platform comprising one or more devices operable to,
generate one or more personalized, modifiable and executable pathway options based on personalized information that comprises a user's desires, likes/dislikes, and interests; and
detect a modification in the personalized information or with an element or component of one of the personalized, modifiable executable pathway options, and insure that all academic course and curricula rules and constraints are met so that the modification does not violate one or more rules.

20. A user device comprising a user interface for communicating with a hardware platform comprising one or more devices, and operable to receive modified, personalized and executable pathway options that meet all constraints and do not violate one or more rules, based on personalized information and the application of results of an academic or career assessment, selected from an Interest Profiler, personal globe inventory, STEM or STEAM assessment, completed by the user from the hardware platform in combination with an associated service, and operable to send the personalized information to the platform.
